(19) United States
(12) Patent Application Publication
(10) Pub. No.: US 2025/0262736 A1
(43) Pub. Date: Aug. 21, 2025

(54) RECIPROCATING IMPACT TOOL WITH IMPACT CONTROL

(71) Applicant: MILWAUKEE ELECTRIC TOOL CORPORATION, Brookfield, WI (US)

(72) Inventors: Tanner J. Vaculik, Brown Deer, WI (US); Kyle W. Schultz, Mequon, WI (US); Troy C. Thorson, Cedarburg, WI (US)

(21) Appl. No.: 19/199,272

(22) Filed: May 5, 2025

Related U.S. Application Data
(63) Continuation-in-part of application No. 19/009,836, filed on Jan. 3, 2025.
(60) Provisional application No. 63/619,520, filed on Jan. 10, 2024.
(60) Provisional application No. 63/624,954, filed on Jan. 25, 2024.

(51) Int. Cl. B25D 11/04; B25D 11/06; B25D 11/12

(52) U.S. Cl. CPC B25D 11/04; B25D 11/12; B25D 11/062; B25D 2211/068; B25D 2250/391

(57) ABSTRACT

A power tool includes a motor, a spindle defining a first end with a slot, and a crankshaft including a counterweight and a crank pin that are rotated by the motor about a crank axis so that at least one of the counterweight and the crank pin is rotated through the slot. The spindle includes a second end opposite the first end and defines a third distance taken between the first end and the second end of the spindle. The spindle further includes an anvil seat between the first end and the second end and defines a fourth distance between the anvil seat and the first end of the spindle. The power tool further includes an anvil received in the spindle, and the anvil defines a bit seat configured to receive a tool bit.

### CROSS-REFERENCE TO RELATED APPLICATIONS

This application is a continuation-in-part of U.S. patent application Ser. No. 19/009,836, filed on Jan. 3, 2025, which claims the benefit of U.S. Provisional Patent Application No. 63/624,954, filed on Jan. 25, 2024, and U.S. Provisional Patent Application No. 63/619,520, filed on Jan. 10, 2024, the disclosures of which are hereby incorporated by reference in its entirety.

### BACKGROUND

A power tool (e.g., a chisel hammer, a rotary hammer, an air hammer, a drill, air chisel, etc.) can be used to drill or impact a workpiece with a bit (e.g., to remove material from the workpiece). An output unit of the power tool can include an impact mechanism that provides power to translate the bit in an axial (i.e., linear) direction. For example, in some applications, the impact mechanism can include a striker that translates in the axial direction to deliver an impact to a tool bit (e.g., via an anvil).

### SUMMARY

According to one aspect of the present disclosure, a power tool can include a motor, a spindle defining a first end with a slot, and a crankshaft including a counterweight and a crank pin. The crankshaft can be rotated by the motor about a crank axis so that at least one of the counterweight and the crank pin is rotated through the slot.

In some examples, the counterweight can include a first distance and the crank pin can include a second distance that is greater than the first distance, with the first distance and the second distance each measured in a direction perpendicular to the crank axis.

In some examples, the spindle can have a second end opposite the first end and can define a third distance taken between the first end and the second end of the spindle. The spindle can include an anvil seat between the first end and the second end, and can define a fourth distance between the anvil seat and the first end of the spindle.

In some examples, a ratio of the fourth distance to the third distance can be between 1:1.5 and 1:2.

In some examples, the power tool can further include a fifth distance between the crank axis and the second end of the spindle, wherein a ratio of the fourth distance to the fifth distance can be between 1:1.5 and 1:2.5.

In some examples, the power tool can further include an anvil received in the spindle, the anvil defining a bit seat configured to receive a tool bit. A sixth distance can be defined between the bit seat and the crank axis when the anvil is in contact with the anvil seat.

In some examples, the sixth distance can be between 130 mm and 160 mm.

In some examples, an average impact energy imparted at the anvil can be between about 7.5 Joules and 9 Joules.

In some examples, a ratio of the sixth distance to an entire length of the power tool, as measured in a direction perpendicular to the crank axis, can be between 1:2 and 1:2.5.

In some examples, a ratio of the third distance to the sixth distance can be between 3:2 and 5:4.

In some examples, a ratio of the sixth distance to the fourth distance can be between 9:1 and 6:1.

In some examples, the power tool can further include a fifth distance between the crank axis and the second end of the spindle, wherein a ratio of the sixth distance to the fifth distance can be between 1:1.5 and 1:1.75.

In some examples, the motor can define a motor axis and the spindle can define a spindle axis, and wherein a ratio of a seventh distance between the motor axis and the spindle axis to an inner diameter of the spindle can be between 1:2 and 3:5.

According to another aspect of the present disclosure, a power tool can include a spindle defining an anvil seat between a first end and a second end, an anvil defining a bit seat configured to receive a tool bit and engaging with the anvil seat to define a characteristic length between the bit seat and the first end of the spindle that is less than about 175 mm, and a crankshaft rotated by a motor about a crank axis to impart impacts at the anvil with an average impact energy that is between about 7.5 Joules and about 9 Joules.

In some examples, the first end of the spindle can define a slot and the crankshaft can include a counterweight that is rotated through the slot.

In some examples, a spindle chamber length defined between the anvil seat and the first end of the spindle can be between about 100 mm and about 125 mm.

In some examples, a distance from the crank axis to the first end of the spindle can be between about 200 mm and about 250 mm.

In some examples, a maximum radius of the counterweight can be between about 20 mm and about 25 mm.

In some examples, the spindle can have an inner diameter that is between about 25 mm and about 35 mm.

According to yet another aspect of the present disclosure, a power tool can include a motor, a spindle defining a first end with a slot and an anvil seat spaced from the first end, an anvil defining a bit seat configured to receive a tool bit and engaging with the anvil seat to define a characteristic length between the bit seat and the first end of the spindle that is less than about 175 mm, and a crankshaft including a counterweight and a crank pin that are rotated by the motor about a crank axis so that at least one of the counterweight and the pin is rotated through the slot.

This Summary and the Abstract are provided to introduce a selection of concepts in a simplified form that can be further described below in the Detailed Description. This Summary and the Abstract are not intended to identify key features or essential features of the claimed subject matter, nor are they intended to be used as an aid in determining the scope of the claimed subject matter.

### BRIEF DESCRIPTION OF THE DRAWINGS

The following drawings are provided to help illustrate various features of non-limiting examples of the disclosure and are not intended to limit the scope of the disclosure or exclude alternative implementations.

FIG. 1 is an axonometric view of a power tool in accordance with aspects of the disclosure.

FIG. 2 is a partial cross-sectional view of an output assembly the power tool of FIG. 1, taken along line 2-2 of FIG. 1.

FIG. 3 is a partial cross-sectional view of the output assembly of the power tool of FIG. 1, taken along line 3-3 of FIG. 1.

FIG. 4 is a detail view of the area taken about line 4-4 of FIG. 2, showing details of an impact mechanism of the output assembly of the power tool of FIG. 1.

FIG. 5 is a partial cross-sectional view of the output assembly of the power tool of FIG. 1, taken along line 5-5 of FIG. 1.

FIG. 6 is an exploded axonometric view of a retainer of the output assembly the power tool of FIG. 1.

FIG. 7 is an enlarged, cross-sectional view of a drive reciprocation drive assembly of the output assembly of the power tool of FIG. 1, taken along line 7-7 of FIG. 1, showing details of a drive piston at a retracted position.

FIG. 8 is a cross-sectional view of the drive piston of FIG. 7 at an extended position.

FIG. 9 is an axonometric view of a transmission of the output assembly of the power tool of FIG. 1.

FIG. 10 is a detail view taken about line 10-10 in FIG. 3, showing details of the drive piston at a fully extended position.

FIG. 11 is a cross-sectional view of the drive piston of FIG. 10 at a first intermediate position between a fully extended position and a fully retracted position.

FIG. 12 is a cross-sectional view of the drive piston of FIG. 10 at a second intermediate position between a fully extended position and a fully retracted position.

FIG. 13 is a cross-sectional view of the drive piston of FIG. 10 at a fully retracted position.

FIG. 14 is a cross-sectional view of the drive piston of FIG. 10 at a third intermediate position between a fully extended position and a fully retracted position.

FIG. 15 is a detail view taken about line 15-15 in FIG. 7, showing details of the transmission and a motor of the power tool of FIG. 1.

### DETAILED DESCRIPTION

The following discussion is presented to enable a person skilled in the art to make and use embodiments of the disclosed technology. Given the benefit of this disclosure, various modifications to the illustrated embodiments will be readily apparent to those skilled in the art, and the principles herein can be applied to other embodiments and applications without departing from embodiments of the disclosed technology. Thus, embodiments of the disclosed technology are not intended to be limited to embodiments shown but are to be accorded the widest scope consistent with the principles and features disclosed herein.

The following detailed description is to be read with reference to the figures, in which like elements in different figures have like reference numerals. The figures, which are not necessarily to scale, depict selected embodiments and are not intended to limit the scope of embodiments of the disclosed technology. Skilled artisans will recognize the examples provided herein have many useful alternatives and fall within the scope of embodiments of the disclosed technology.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

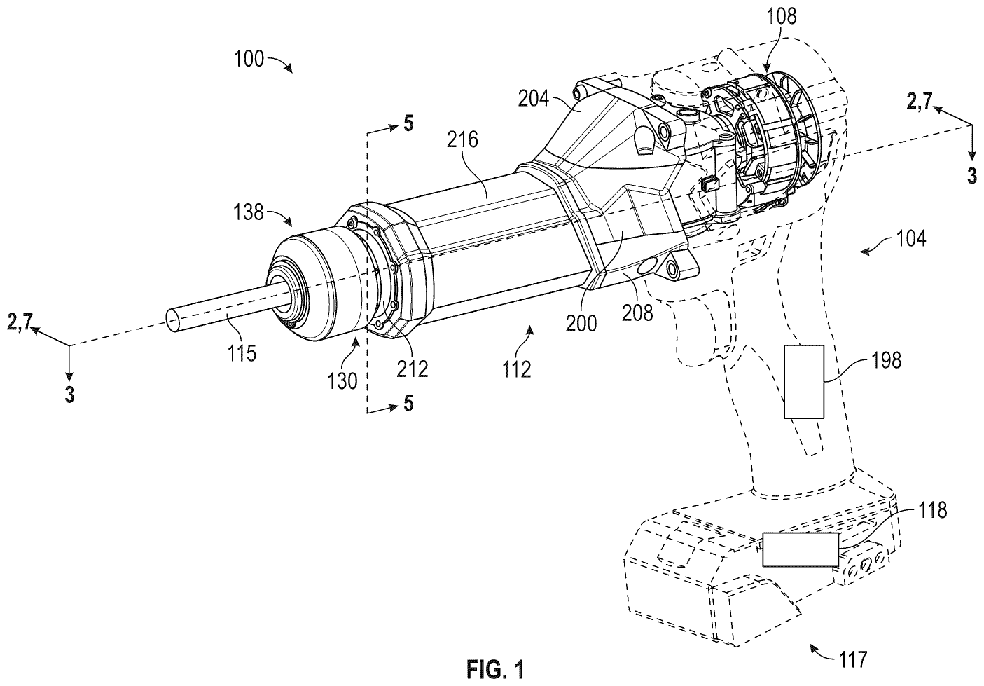

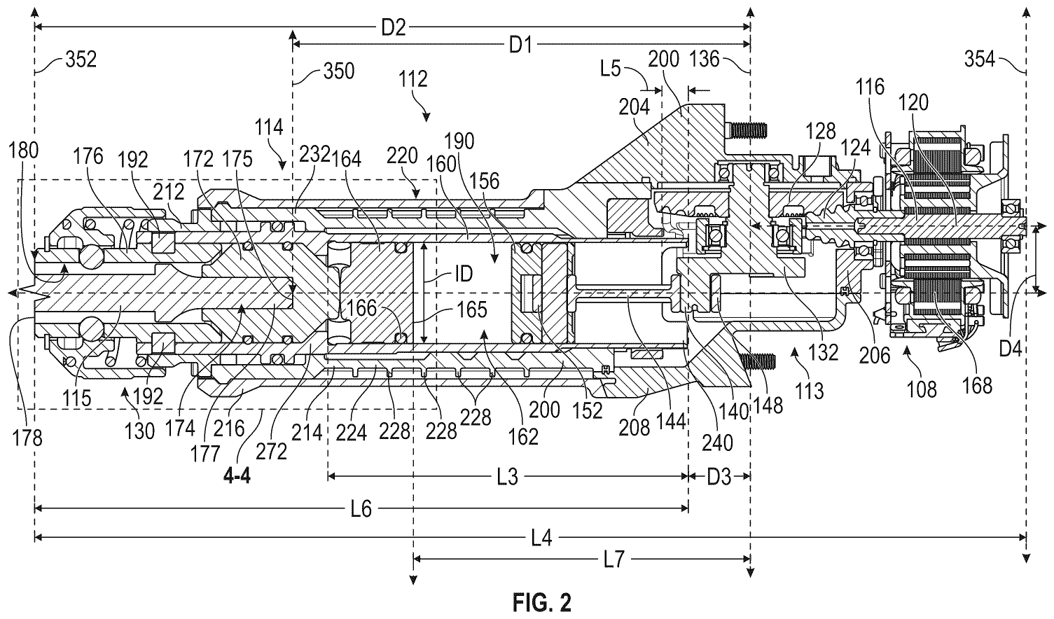

Examples of the disclosed technology can be implemented on any variety of power tools that operate with removable bits. In particular, some examples may be used with impact drivers, including chisel hammers, rotary hammers or other known implementations. In this regard, for example, FIG. 1-3 illustrate a power tool 100 in the form of a hammer tool (e.g., a chisel hammer), however the concepts described herein can also be applied to other types of power tool. The power tool 100 includes a housing 104 and an electric motor 108 disposed within the housing 104. The power tool 100 can further include a reciprocation drive assembly 113 (shown in FIG. 2) coupled to the motor 108 for converting torque from the motor 108 (e.g., as the motor 108 rotates about a motor axis 120) to reciprocating motion. In some examples, the reciprocation drive assembly 113 can be coupled to the motor 108 via a transmission 112. An impact mechanism 114 can be coupled to the reciprocation drive assembly 113 to impart repeating axial impacts on a tool bit 115 (e.g., a chisel bit or an output tool). As shown in FIG. 1, the tool bit 115 may be slidably supported by a tool holder 130 coupled to the housing 104 so that the tool bit 115 is permitted to translate along its axis to impart the axial impacts to a work piece. In the illustrated example, the power tool 100 includes a quick-connect mechanism 138 coupled to the tool holder 130 to facilitate quick removal and replacement of different tool bits 115. In other applications, other types of chucks can be used in place of the quick connect mechanism 138, as may allow for tooled or toolless bit changes.

In some cases, the housing 104 includes different pieces that support different parts of the power tool 100. For example, the housing 104 can include a pair of clamshell halves that provide an outer cover for the power tool 100. In some cases, the housing 104 can include a gear case 200 that house one or more of the transmission 112, the reciprocation drive assembly 113, or the impact mechanism 114. In the illustrated example, the gear case 200 includes an upper gear case cover 204, a central gear case cover 206, a lower gear case cover 208, and a gear case cap 212.

Continuing, in the illustrated example of the power tool 100, the motor 108 can be configured as a direct-current (DC) motor 108 that receives power from an on-board power source (e.g., a battery pack 118). The housing 104 can define a battery receptacle 117 that detachably receives the battery pack 118. The battery pack 118 may include any of a number of different nominal voltages (e.g., 12V, 18V, etc.), and may be configured having a Lithium-based chemistry (e.g., Lithium, Lithium-ion, etc.) or any other suitable chemistry. Alternatively, the motor 108 may be powered by a remote power source (e.g., a household electrical outlet) through a power cord or the motor 108 can be a different type of motor, such as an alternating-current (AC) motor. The motor 108 is selectively activated by depressing a trigger which, in some cases, may activate an internal switch. The switch may be electrically connected to the motor 108 via a top-level or master controller 198 (e.g., a microcontroller), or one or more circuits, for controlling operation of the motor 108.

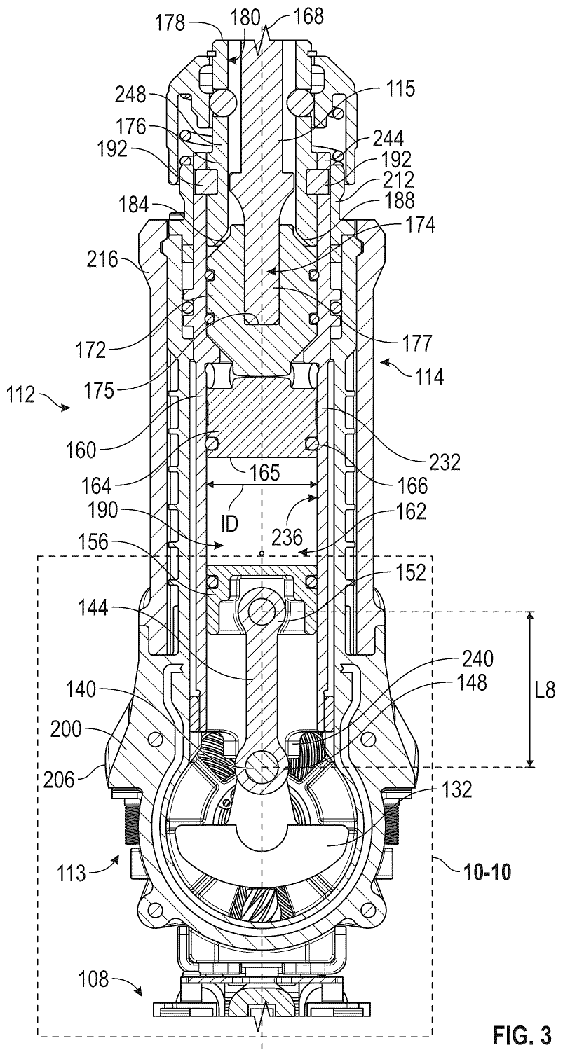

With specific reference to FIGS. 2 and 3, the gear case 200 includes a spindle case 214 that can support a spindle 160 (e.g., barrel). The spindle case 214 is covered by a boot 216. In some cases, the boot 216 may be formed from a thermally insulating material (e.g., rubber, fiberglass, mineral wool, cellulose, polyurethane, polystyrene, etc.). In some cases, the boot 216 can include a gripping region 220 that may be gripped by the user (e.g., while operating the power tool 100). For example, during operation of the power tool 100, frictional forces, vibration, expansion and contraction of an air pocket within the spindle 160, operation of the motor 108, or other factors can generate heat which can increase a temperature of the gear case 200. Accordingly, the boot 216 may provide an insulation layer for the user's hand from the gear case 200. In some cases, the boot 216 can include a relatively high coefficient of friction in the gripping region 220 and prevent the power tool 100 from slipping out of the user's hand during operation.

Further, the gripping region 220 include heat dissipating elements. For example, the spindle case 214 can include a wall 224 and a plurality of ribs 228 extending from the wall 224. In this case, the wall 224 and the ribs 228 are respectively configured as a cylindrical wall and circumferential ribs, however, other wall rib configurations are possible. The ribs 228 can protrude outwardly from the wall 224 toward the boot 216 and are spaced apart from one another in a direction parallel to a reciprocation axis 168 (e.g., an impact axis). As shown in FIGS. 2 and 3, in the gripping region 220 of the boot 216, the ribs 228 contact the boot 216 and minimizes a contact area between the boot 216 and the gear case 200. Accordingly, a reduced amount of heat can be transferred directly from the gear case 200 to the boot 216 and insulate the user's hand when positioned on the gripping region 220.

With continued reference to FIGS. 2 and 3, a reciprocation drive assembly can be configured to convert rotational motion of a motor (e.g., via a transmission) into reciprocating linear motion of a piston. In the illustrated example, the reciprocation drive assembly 113 includes a crankshaft 132, a reciprocating piston 156, and a connecting rod 144. The connecting rod 144 is connected to the crankshaft 132 at a first end 148 and a second end 152 that is opposite the first end 148. In some cases, the connecting rod 144 can be pivotably coupled to the crankshaft 132 at each of the first end 148 and the second end 152. The crankshaft 132 is configured to receive torque from the motor 108 and rotate about a crank axis 136 (e.g., crankshaft axis). In the illustrated example, the crankshaft 132 includes a crank pin 140 that couples to the first end 148 of the connecting rod 144, which can be coupled to the piston 156 at the second end 152. Correspondingly, as the crankshaft 132 rotates about the crank axis 136, the connecting rod 144 drives the piston 156 to reciprocate along the reciprocation axis 168 and within the spindle 160 supported within the housing 104. As shown in FIG. 3, the connecting rod 144 includes a length L8 (e.g., a connecting rod length) that is measured between an axis corresponding with a connection to the crank pin 140 and an axis corresponding with a connection to the piston 156. In some cases, the length L8 can be between 35 mm and 65 mm, or between 40 mm and 50 mm, or about 45 mm. In the illustrated example, the spindle 160 is stationary. However, in other examples, such as rotary hammers, the spindle 160 can be rotated by the motor 108 to cause rotation of a tool bit.

In some embodiments, the reciprocation drive assembly 113 can be realized by other mechanisms, including those known in the art to convert rotational motion to reciprocating motion (e.g., a scotch-yoke mechanism, a wobble drive mechanism, a swash plate mechanism, etc.). In this regard, although the various tool holders discussed below may be utilized in combination with the illustrated reciprocation drive assembly 113, various other implementations are also possible.

A reciprocation assembly moves to generate impact to a tool bit via an impact mechanism. That is, the impact mechanism moves in response to movement of the reciprocation assembly to impact a tool bit. In the illustrated example, the impact mechanism 114 includes a striker 164 and an anvil 172 that are moveably received in the spindle 160. The striker 164 is positioned between the piston 156 and the anvil 172 and selectively reciprocates within the spindle 160 in response to reciprocation of the piston 156. The anvil 172, which engages the tool bit 115, is impacted by the striker 164 when the striker 164 reciprocates toward the tool bit 115. The impact between the striker 164 and the anvil 172 can be transferred to the tool bit 115, causing the anvil 172 to reciprocate along with the tool bit 115 performing work on a work piece (e.g., impact a workpiece). In the illustrated example, the anvil 172 includes an inner bore 174 that receives a shank 177 of the tool bit 115. Further, in the illustrated construction of the power tool 100, the spindle 160 is hollow and defines an interior chamber 162 (e.g., a bore) in which the striker 164 is received. An air spring 190 (e.g., an air pocket or an air cushion) can be formed between the piston 156 and the striker 164 when the piston 156 reciprocates within the spindle 160, whereby expansion and contraction of the air spring 190 induces reciprocation of the striker 164. That is, as the piston 156 moves towards the striker 164, the volume of the air spring 190 is reduced, which increases pressure within the air spring 190. This increase in pressure can be sufficient to move the striker 164 in the same direction as piston 156 and cause the striker 164 to impact the anvil 172 to deliver an impact to a workpiece via the bit 115. Conversely, as the piston 156 moves away from the striker 164, the volume of the air spring 190 can increase, which reduces pressure within the air spring 190. This reduction in pressure can be sufficient to move the striker 164 in the same direction as piston 156, causing the striker 164 to retract and move away from the anvil 172.

In some cases, the striker 164 or the anvil 172 can form a seal against an interior surface of the spindle 160 via one or more sealing rings (e.g., an O-ring 166). In some examples, maintaining the seal between the striker 164 and the spindle 160 can help to maintain the air spring 190 formed within the interior chamber 162.

In some non-limiting cases, the motor 108 can be positioned within the housing 104 (e.g., within a gearcase disposed within the housing 104), and the spindle 160 can be coupled to the housing 104. In some non-limiting cases, the motor 108 can be positioned within the housing 104, the spindle 160 can be rotatable. For example, the transmission 112 between the motor 108 and the spindle 160 can transmit torque from the motor 108 to the spindle 160, causing the spindle 160 to rotate when the motor 108 is activated. The transmission 112 can include a geartrain, although other types of transmission systems can be used, for example, belt drives, chain drives, etc.

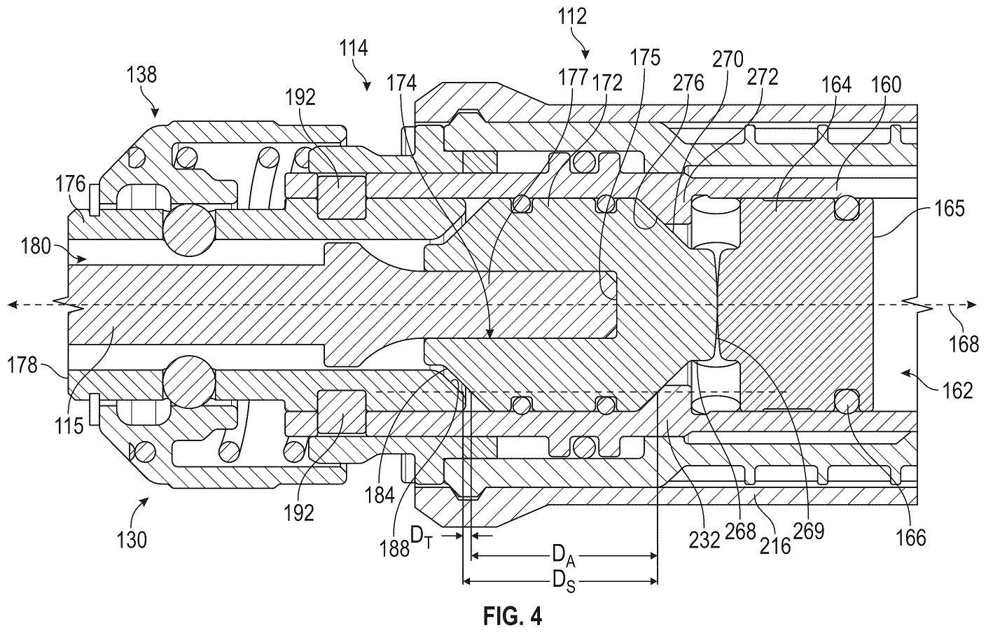

Continuing, the power tool 100 includes retainment features that guide an axial movement of the anvil 172 along the reciprocation axis 168. For example, as shown in FIG. 4, a retainer 176 is provided at a distal end of the spindle 160. The retainer 176 defines a bore 180 (e.g., a cylindrical bore) that can receive the tool bit 115. In the illustrated example, the retainer 176 is coupled to the spindle 160 via fasteners (e.g., fasteners or retention members). The retainer 176 defines a retainer impact surface 188 that can engage with a corresponding surface of the anvil 172. In the illustrated example, the anvil 172 defines a front anvil impact surface 184 that generally faces toward a front of the power tool 100 (e.g., toward the tool holder). When the anvil 172 moves toward the front of the power tool 100 along the reciprocation axis 168, the retainer impact surface 188 can engage with the front anvil impact surface 184 and stop a further movement of the anvil 172 toward the front of the power tool 100. In the illustrated example, a profile of the front anvil impact surface 184 generally corresponds to a profile of the retainer impact surface 188. For example, each of the impact surfaces 184, 188 can be frustoconical in shape. In other embodiments, the profiles of the front anvil impact surface 184 and the retainer impact surface 188 can be different or include different shapes (e.g., pyramidal, cylindrical, spherical, cubical, cuboidal, conical, etc.).

Further, the anvil 172 is configured to engage with the spindle 160 during the reciprocation motion of the power tool 100. For example, as shown in FIG. 4, the anvil 172 defines a rear anvil impact surface 268 located at a rear end of the anvil 172, generally opposite from the front anvil impact surface 184. The rear anvil impact surface 268 includes a first rear surface 269 that can (directly) engage with the striker 164 during the reciprocation motion and a second rear surface 270 that can engage with the spindle 160. In some cases, the rear anvil impact surface 268 can be arranged to generally face toward a rear of the power tool 100 (e.g., toward the striker 164). In the illustrated example, the second rear surface 270 is generally conically shaped, and the first rear surface 269 protrudes from the second rear surface 270 toward the striker 164. Further, the second rear surface 270 engages with a corresponding surface of the spindle 160. In particular, the spindle 160 can include a rib 272 that protrudes from a spindle wall 232 of the spindle 160 and extends circumferentially along an interior surface of the spindle wall 232. The rib 272 can define a spindle impact surface 276 that is arranged toward the second rear surface 270 of rear anvil impact surface 268. Accordingly, when the anvil 172 moves toward the rear of the power tool 100 along the reciprocation axis 168, the spindle impact surface 276 can engage with the second rear surface 270 and stop a further movement of the anvil 172 toward the rear of the power tool 100. In some cases, a profile of the spindle impact surface 276 can generally correspond to a profile of the second rear surface 270. For example, each of the impact surfaces 270, 276 can be frustoconical in shape. In other embodiments, the profiles of the rear anvil impact surface 268 and the spindle impact surface 276 can be different or include different shapes (e.g., pyramidal, cylindrical, spherical, cubical, cuboidal, conical, etc.).

In some configurations, the retainer 176 or the spindle 160 can absorb an impact force exerted by the striker 164 to the anvil 172 along the reciprocation axis 168 when the anvil 172 contacts the retainer 176 or the spindle 160 directly or indirectly. For example, repeated impacts by the striker 164 to the anvil 172 can cause the anvil 172 to reciprocate between the retainer 176 and the spindle 160. When the anvil 172 impacts the retainer 176, the impact force can be absorbed by the spindle 160 that is coupled to the anvil 172 via the retention members 192.

In these circumstances, the retainer 176 and the spindle 160 can provide impact absorbing features that absorb at least portion of the impact force exerted by the striker 164 or the reactionary force exerted by a workpiece during operation. For example, when the anvil 172 moves back toward the spindle 160, the rear anvil impact surface 268 can contact the spindle impact surface 276. The impact force can be transmitted to the spindle 160, dissipating the force through the spindle 160. When the anvil 172 moves forward toward the retainer 176, the front anvil impact surface 184 can contact the retainer impact surface 188. The impact force exerted by the striker 164 can be transmitted to the anvil 172, and the transmitted impact force can be subsequently transmitted to the retainer 176 and the spindle 160 via the retention members 192. Correspondingly, the impact force exerted by the striker 164 can be dissipated by directing the force to the spindle 160 or other parts of the power tool 100.

With conventional power tool designs, impacts may occur even when a tool bit is not in contact with a workpiece, causing dry-firing. To prevent impacts from being created when a power tool is not contacting a workpiece with a tool bit, as can reduce operator fatigue and tool wear, conventional designs for impacting tools provide a parking feature in which a striker is prevented from reciprocating within a spindle. For example, O-rings are included to restrain anvil movement and prevent contact between the striker and anvil. However, such parking features add complexity to the manufacturing process and increase the overall size of the tool. According to aspects of the present disclosure, providing a retainer for an anvil and a protruded wall in a spindle can reduce or eliminate the need for a parking feature (e.g., to prevent dry firing), which can typically increase a length of the power tools. For example, by arranging an anvil between a retainer (e.g., the retainer 176) and a protruded wall (e.g., the rib 272), a travel length of the anvil can be limited or reduced between the retainer and the protruded wall and improve efficiency of the power tool.

In particular, with continued reference to FIG. 4, a travel distance Dr can be defined as a difference between a stop surface distance D_{S} and an anvil impact surface distance D_{A} (i.e., D_{T}=D_{S}−D_{A}), wherein each of the respective distances is taken along the same line extending in the axial direction (e.g., approximately parallel with the axis 168). For example, the stop surface distance D_{S} is measured between the retainer impact surface 188 and the spindle impact surface 276, and the anvil impact surface distance D_{A} is measured between the front anvil impact surface 184 and the rear anvil impact surface 268. In some cases, the travel distance Dr can be the distance that the anvil 172 can travel along the reciprocation axis 168 between the retainer 176 or the spindle 160, or being limited by other components of the power tool 100. In the illustrated embodiment, the stop surface distance D_{S} can be greater than the anvil impact surface distance D_{A} by a small distance. Correspondingly, the travel distance D_{T} of the anvil 172 can be less than the stop surface distance D_{S}. For example, in some embodiments, the travel distance Dr can be less than or equal to 50% of the stop surface distance D_{S}. In other embodiments, the travel distance D_{T} can be less than or equal to 25% of the stop surface distance D_{S}. In the illustrated embodiment, the travel distance Dr can be less than or equal to 20% of the stop surface distance D_{S}. In further embodiments, the travel distance D_{T} can be less than or equal to 10% of the stop surface distance D_{S}. By dissipating the impact forces generated during operation of the power tool 100 into the retainer 176, the retention members 192 and the spindle 160, the need for a parking feature can be reduced or eliminated, and the travel distance D_{T} can be reduced relative to the stop surface distance D_{S}, which advantageously allows an overall length of the power tool 100 to be reduced as compared to traditional chisel hammers.

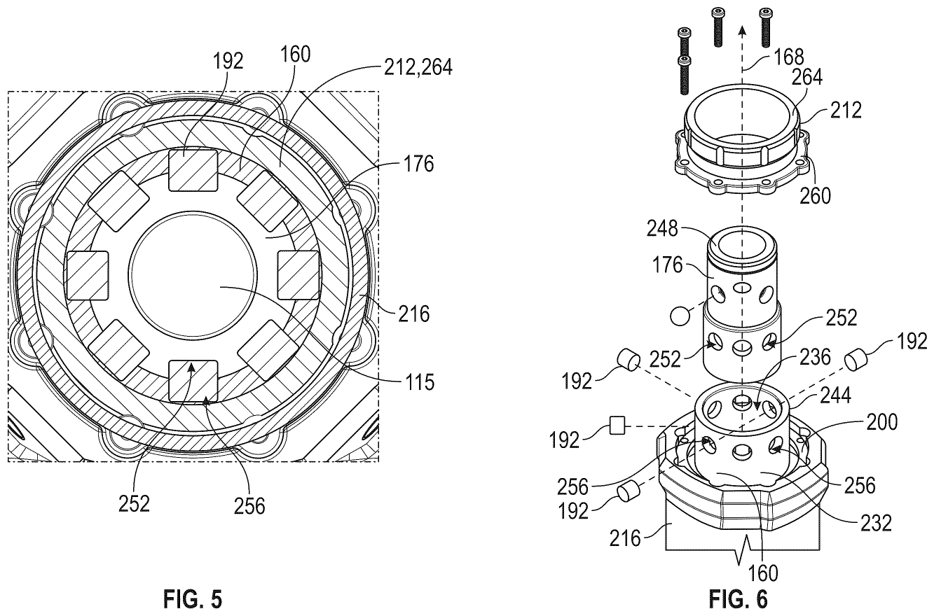

FIGS. 5 and 6 illustrate details of the retainer 176 and surrounding features. In particular, the spindle 160 can include the spindle wall 232 that defines a bore 236 within which the drive piston 156, the striker 164, and the anvil 172 reciprocate. The spindle 160 includes a proximal end 240 (e.g., shown in FIGS. 2 and 3) located proximate the motor 108 and a crank axis 136 that a gear 128 rotates about, and a distal end 244 located distant from the motor 108 and toward the front of the power tool 100. The retainer 176 can include a retainer wall 248. A portion of the retainer wall 248 can be received into the bore 236 at the distal end 244 of the spindle 160, in close fit with the spindle wall 232 (e.g., nominal slip fit).

The retainer 176 can include features and elements for coupling with the spindle 160. For example, the retainer wall 248 can define a plurality of recesses 252 that are circumferentially spaced apart from one another and aligned axially with respect to the reciprocation axis 168. In some cases, the recesses 252 can be sized and shaped to receive the retention members 192. In the illustrated embodiment, the retention members 192 are cylindrically shaped and recesses 252 are correspondingly cylindrically shaped to receive respective portions of the retention members 192. In other embodiments, the retention members 192 may instead include different shapes (e.g., ovoid, spherical, frustoconical, prismatic, arc-shaped, etc.), and the recesses 252 can be correspondingly shaped to (tightly) receive the retention members.

Similarly, the spindle 160 can include features and elements for coupling with the retainer 176. For example, the spindle wall 232 can define a plurality of apertures 256 extending therethrough, so that the bore 236 can be accessed through the plurality of apertures 256. The apertures 256 can be circumferentially spaced apart from one another and aligned axially with respect to the reciprocation axis 168. The apertures 256 can be sized and shaped to receive respective portions of the retention members 192. In the illustrated embodiment, the retention members 192 are cylindrically shaped and apertures 256 are correspondingly cylindrically shaped to tightly receive respective portions of the retention members 192. In other embodiments, the apertures 256 can include different shapes to (tightly) receive correspondingly shaped retention members which may not be cylindrically shaped.

With continued reference to FIGS. 5 and 6, the recesses 252 of the retainer 176 can be aligned with the apertures 256 of the spindle 160. The retention members 192 can be provided through the recesses 252 and the apertures 256. In particular, a first portion of each retention member 192 can be arranged in a respective recess 252 and a second portion (e.g., remaining portion) of each retention member 192 can be arranged in the corresponding aligned aperture 256. Therefore, the retention members 192 can provide a coupling mechanism to couple the retainer 176 to the spindle 160.

In some cases, the gear case cap 212 can be provided at the distal end 244 of the spindle 160 and retain the retention members 192 within the recesses 252 and the apertures 256. The gear case cap 212 can include a flange 260 and a cap wall 264 that extends axially away from the flange 260. In some cases, the cap wall 264 can be cylindrically shaped, although other shapes are possible. The cap wall 264 be fitted over the distal end 244 adjacent the retention members 192 and retain the retention members 192 in place within the recesses 252 and the apertures 256. In some cases, the flange 260 can be secured to the gear case 200 (e.g., via fasteners such as screws or adhesives).

In some cases, the retention members 192 can be formed from a first material that includes a first Young's modulus. The spindle 160 can be formed from a second material that includes a second Young's modulus. The retainer 176 can be formed from a third material that includes a third Young's modulus. In some cases, the first, second, and third materials can each include a hard and rigid material (e.g., metals, hardened steel, etc.). In other embodiments, different types of materials with different rigidities can be provided, including elastomer, rubber, wood, plastic, concrete, glass, high permeability materials, low permeability materials, ferrous material, etc. In some embodiments, the first Young's modulus can be equal to or greater than the second Young's modulus and equal to or greater than the third Young's modulus. In some cases, two or more of the first, second, and third materials can be the same or different.

Further, in the illustrated embodiment, the power tool 100 includes eight retention members 192 and eight corresponding recesses 252 and apertures 256, which are spaced at equal intervals circumferentially about the spindle 160. In other embodiments, the power tool 100 may include fewer number of retention members, corresponding recesses, and corresponding apertures (e.g., one, two, three, four, five, six, or seven). In some embodiments, the power tool 100 can include a greater number of retention members, corresponding recesses, and corresponding apertures (e.g., greater than eight).

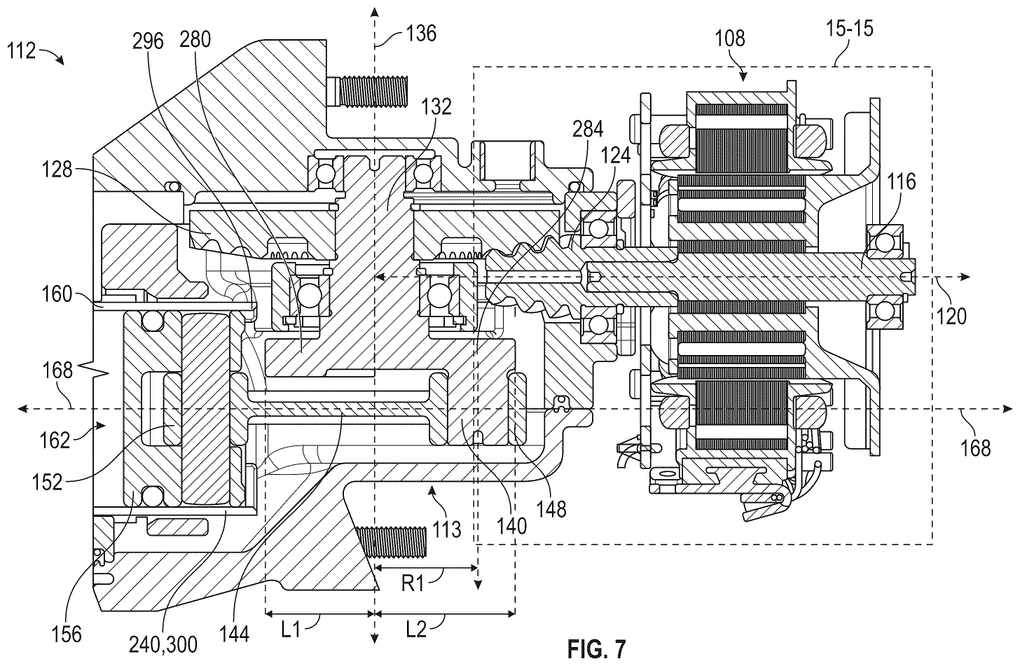

FIGS. 7-9 illustrate the motor 108, the transmission 112, and the reciprocation drive assembly 113 in greater detail. In particular, the crankshaft 132 includes a counterweight 280 and a crank 284 that includes the crank pin 140. The counterweight 280 can be defined by a distance L1 (e.g., a radial distance, a first distance) that is measured along a direction of the reciprocation axis 168 between the crank axis 136 and a first distal edge of the counterweight 280. The crank 284 can further be defined by a distance L2 (e.g., a radial distance, a second distance) that is measured along the direction of the reciprocation axis 168 between the crank axis 136 and a second distal edge of the counterweight 280, on a side that includes the crank 284. In the illustrated example, the distance L1 of the counterweight 280 is shorter than the distance L2 of the crank 284. In some cases, the shorter distance L1 can permit the counterweight 280 to avoid contact with the drive piston 156 when the drive piston 156 is at a fully retracted position (e.g., at a bottom dead center position, as shown in FIG. 7). In some cases, the larger distance L2 of the crank 284 can increase a crank radius R1 of the crank pin 140. In particular, as shown in FIG. 7, the crank radius R1 is a distance between the crank axis 136 and an axis of the crank pin 140. However, the illustrated example provides an arrangement of the crank 284, such that the crank 284 can be arranged closer to the transmission 112, or be rotated away from the drive piston 156 at the bottom dead center position without an interference with the drive piston 156, the spindle 160, or other parts of the transmission 112. In some cases, the crank radius R1 (e.g., as shown in FIG. 7) can be between 10 mm and 25 mm, or between 15 mm and 20 mm, or about 17 mm. The distance L1 can be between 13 mm and 23 mm, or between 15 mm and 20 mm, or about 18 mm. The distance L2 can be between 15 mm and 30 mm, or between 20 mm and 25 mm, or about 23 mm. In some examples, the distance L2 can be configured as a maximum radius of the counterweight 280.

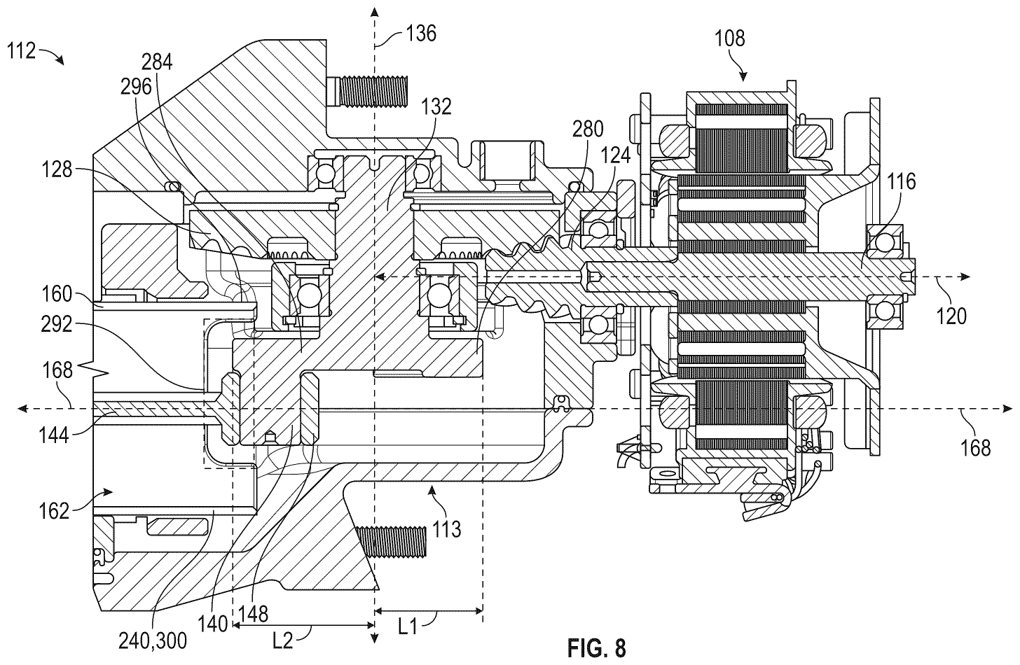

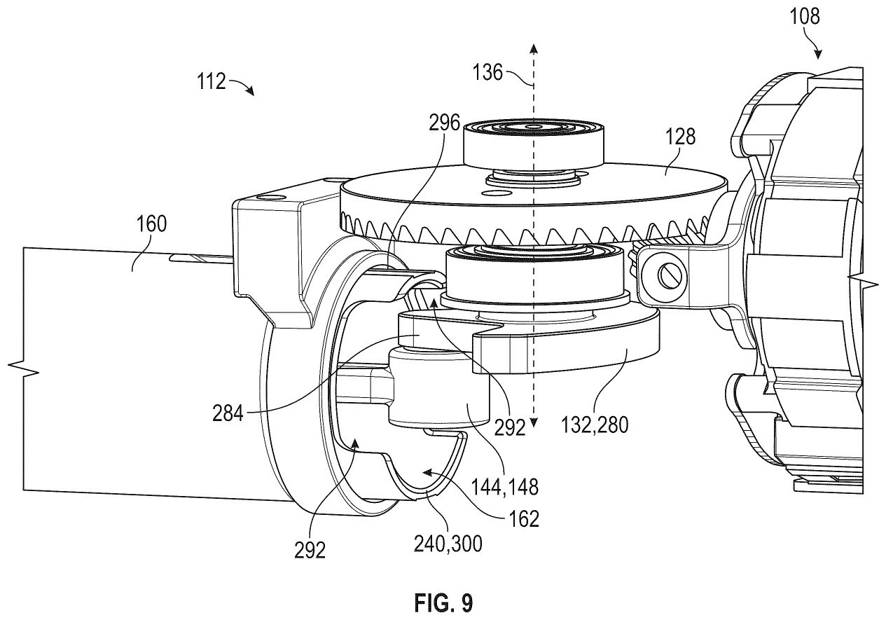

In particular, as best shown in FIG. 9, the proximal end 240 of the spindle 160 can include a plurality of cutouts or slots 292 located at each respective lateral side of the spindle 160. In some cases, each of the slots 292 can be defined between an upper rim 296 of the spindle 160 and a lower rim 300 of the spindle 160. In the illustrated example, the spindle 160 is arranged below the gear 128, and the crank 284 can at least partially overlap with the upper rim 296 and the lower rim 300 in a direction parallel to the crank axis 136 when the drive piston 156 is at a fully extended position (e.g., at a top dead center position, as shown in FIGS. 8-10). Put differently, When the drive piston 156 is approaching or returning from the fully extended position, at least a portion of the crank 284 of the crankshaft 132 can pass between the upper and lower rims 296, 300 of the spindle 160. Accordingly, the slots 292 can permit the crank 284 to rotate about the crank axis 136 and provide translating movement to the drive piston 156 without interfering the spindle 160 (e.g., which remains stationary in chisel hammers) or the drive piston 156. In the illustrated example, the piston 156 can maintain a skirt engagement with the spindle 160 by contacting the upper rim 296 and the lower rim 300 and can be prevented from twisting within the spindle 160 during operation. In some examples, maintaining the skirt engagement between the piston 156 and the spindle 160 can be helpful for preserving tool life by reducing excess side loading on interior wall of the spindle 160 and maintaining piston alignment within the bore of the spindle 160.

In some cases, the illustrated configuration of the spindle 160 can allow for a compact arrangement of the reciprocation drive assembly 113 or the transmission 112 within the gear case 200 and a shorter overall length of the power tool 100. For example, the slots 292 or other types of slotted geometry of the spindle 160 can allow for the distance L2 that is greater than the distance L1 and achieve a desired level of performance of the power tool 100 (e.g., an average impact energy of about 7.5 Joules to about 9 Joules). Further, the slots 292 or other types of slotted geometry of the spindle 160 can allow for a shorter geometry of the connecting rod 144. In some examples, the configurations of the reciprocation drive assembly 113 can provide a desired length L7 (e.g., an impact position length, as shown in FIG. 2) between the crank axis 136 and a rear surface 165 of the striker 164. In some examples, the length L7 can be between 50 mm and 150 mm, or between 75 mm and 125 mm, or about 106 mm. In some examples, a ratio of the length L7 to the crank radius R1 can be less than 6.75, or less than 6.50, or less than 6.25. In the illustrated example, the ratio of the length L7 to the crank radius R1 is about 6.18. In some examples, a ratio of the length L7 to the length L8 of the connecting rod 144 can be greater than 1.80, or greater than 1.90, or greater than 2.00. In the illustrated example, the ratio of the length L7 to the length L8 of the connecting rod 144 is about 2.35. In some examples, a ratio of the crank radius R1 to the length L8 can be greater than 0.24, or greater than 0.30. In the illustrated example, the ratio of the crank radius R1 to the length L8 is 0.38. In some cases, a higher ratio of the crank radius R1 to the length L8 can be associated with a smaller angle (e.g., the angle A1 or the angle A2) between the crank 284 and the connecting rod 144. In further examples, a ratio of the impact energy of the power tool 100 to the length L8 can be greater than 0.13, or greater than 0.17, or greater than about 0.20.

Further, while the illustrated embodiment of the reciprocation drive assembly 113 includes a crank mechanism, the reciprocation drive assembly 113 can include other types of mechanisms, including a wobble bearing mechanism, a scotch yoke mechanism, a rack and pinion mechanism, a cam shaft mechanism, a swash plate mechanism, etc. For example, in the reciprocation drive assembly 113 including a wobble bearing mechanism, the crank radius R1 (e.g., a throw distance) can be equivalent to a length of a piston throw of the wobble bearing mechanism.

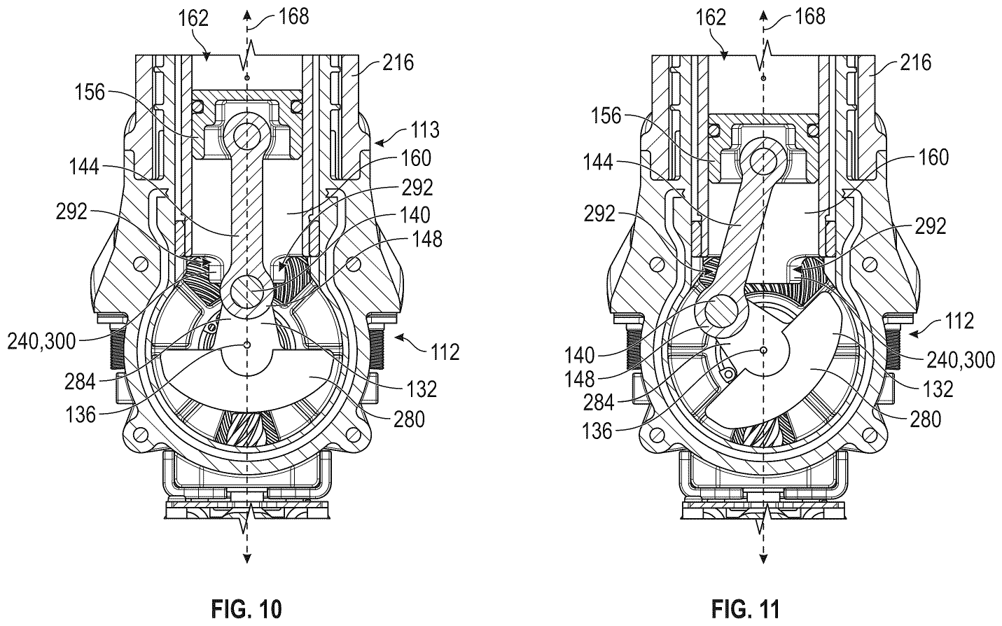

FIGS. 10-14 illustrate operational views of the transmission 112 and the reciprocation drive assembly 113 at different positions. As generally described above, the spindle 160 can include features that permit a rotational movement of the crank 284 without interference between a fully extended position and a fully retracted position of the drive piston 156.

FIG. 10 illustrates the drive piston 156 at a fully extended position (e.g., at the top dead center position). In the illustrated example, the connecting rod 144 is aligned along the reciprocation axis 168. A portion of the crank 284 and the crank pin 140 are at least partially arranged within the spindle 160 at the proximal end 240. For example, the crank 284 and the crank pin 140 at least partially overlap with the upper rim 296 (e.g., shown in FIGS. 7-9) and the lower rim 300. The counterweight 280 is arranged toward a rear end of the power tool 100 (e.g., toward the motor 108).

FIG. 11 illustrates the drive piston 156 at a partially retracted (e.g., or partially extended), first intermediate position between the fully extended position (e.g., shown in FIG. 10) and the full retracted position (e.g., shown in FIG. 13). In the illustrated example, the crankshaft 132 is rotated to a 45-degree position in a counterclockwise direction from the fully about the crank axis 136, and the connecting rod 144 is arranged at an oblique angle relative to the reciprocation axis 168. In some cases, at least a portion of the connecting rod 144 can be arranged in one of the slots 292 arranged between the upper rim 296 (e.g., shown in FIGS. 7-9) and the lower rim 300. At this position, the crank 284 and the crank pin 140 are arranged outside of the spindle 160. The counterweight 280 can be rotated about the crank axis 136 by 45 degrees.

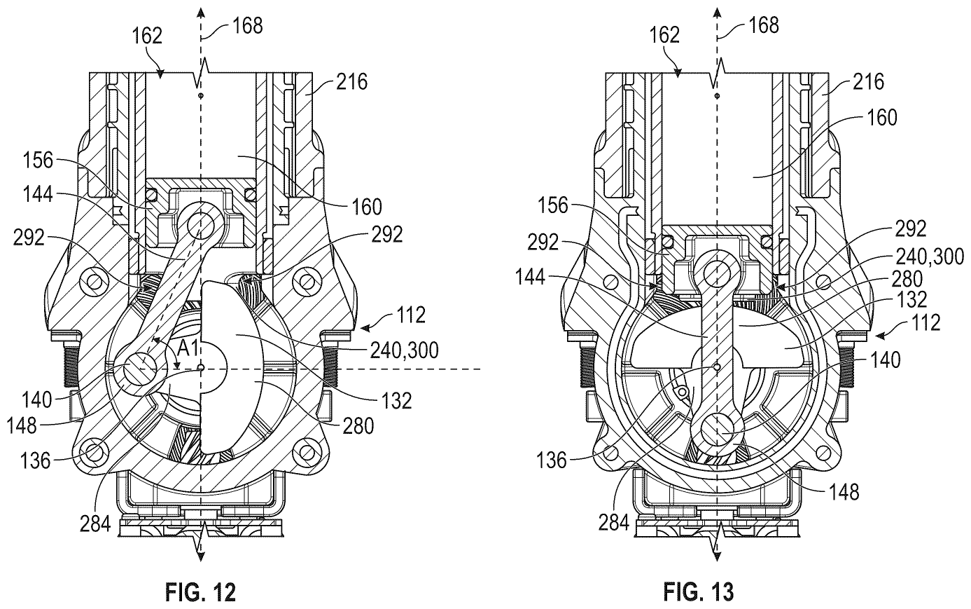

FIG. 12 illustrates the drive piston 156 at another partially retracted, second intermediate position, which includes the drive piston 156 translated further toward a motor-side of the power tool 100. In the illustrated example, the crankshaft 132 is rotated to a 90-degree position in a counterclockwise direction from the 45-degree position about the crank axis 136. The connecting rod 144 is arranged at an oblique angle relative to the reciprocation axis 168. In particular, an angle A1 between the connecting rod 144 and the crank 284 can be between 60° and 80°, or between 65° and 75°, or about 68°. At this position, at least a portion of the connecting rod 144 can be arranged in the slot 292. The crank 284 and the crank pin 140 are arranged outside of the spindle 160, and a portion of the counterweight 280 is arranged within the spindle 160 between the upper rim 296 (e.g., shown in FIGS. 7-9) and the lower rim 300. In particular, the counterweight 280 can slid into the slot 292 when the crankshaft 132 is rotated from the 45-degree position to the 90-degree position. Accordingly, the crankshaft 132 can rotate without interfering with the spindle 160 or the piston 156, and the piston 156 can continue to translate within the spindle 160 along the reciprocation axis 168.

FIG. 13 illustrates the drive piston 156 at a fully retracted position. In the illustrated example, the crankshaft 132 is rotated to a 180-degree position in a counterclockwise direction from the 90-degree position about the crank axis 136. At this position, the drive piston 156 can be located at the bottom dead center position. A portion of the drive piston 156 can axially overlap with the slots 292 and be positioned between the upper rim296 and the lower rim 300. In some cases, the upper and lower rims 296, 300 can protrude beyond the drive piston 156, i.e., closer to the crank axis 136, in this position. Further, the counterweight 280 can be proximate the proximal end 240 of the spindle 160 and arranged outside the spindle 160. The connecting rod 144 can axially overlap with the counterweight 280 above the counterweight 280, and the connecting rod 144 can extend along the reciprocation axis 168.

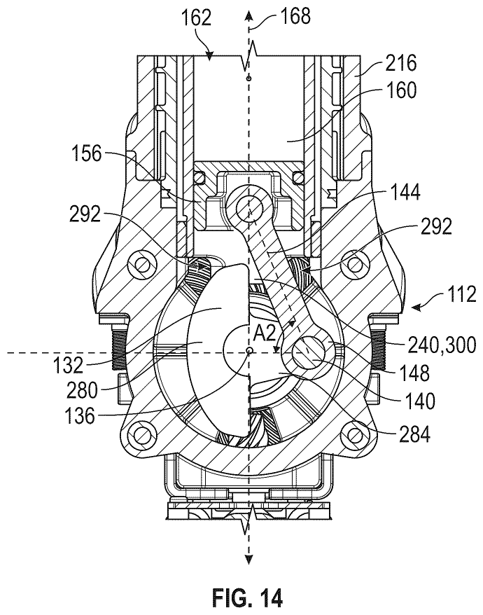

FIG. 14 illustrates the drive piston 156 at a partially retracted, third intermediate position between the fully extended position and the fully retracted position of the drive piston 156. In the illustrated example, crankshaft 132 is rotated to a 270-degree position in a counterclockwise direction from the 180-degree position about the crank axis 136. The connecting rod 144 is arranged at an oblique angle relative to the reciprocation axis 168. In particular, an angle A2 between the connecting rod 144 and the crank 284 can be between 60° and 80°, or between 65° and 75°, or about 68°. At this position, a portion of the connecting rod 144 can be arranged in one of the slots 292, and a portion of the counterweight 280 can be arranged in the other one of the slots 292.

In some cases, the drive piston 156 can continue to extend from the 270-degree position as shown in FIG. 14 to complete one stroke of the drive piston 156. In some cases, the crankshaft 132 can rotate in a clockwise direction, in a reverse direction than as described above. By allowing portions of the crankshaft 132 to slide through the slots 292 as the crankshaft 132 rotates about the crank axis 136, the drive piston 156 can continue its reciprocating motion while without an interference and while maintaining a compact arrangement of the components within the power tool 100.

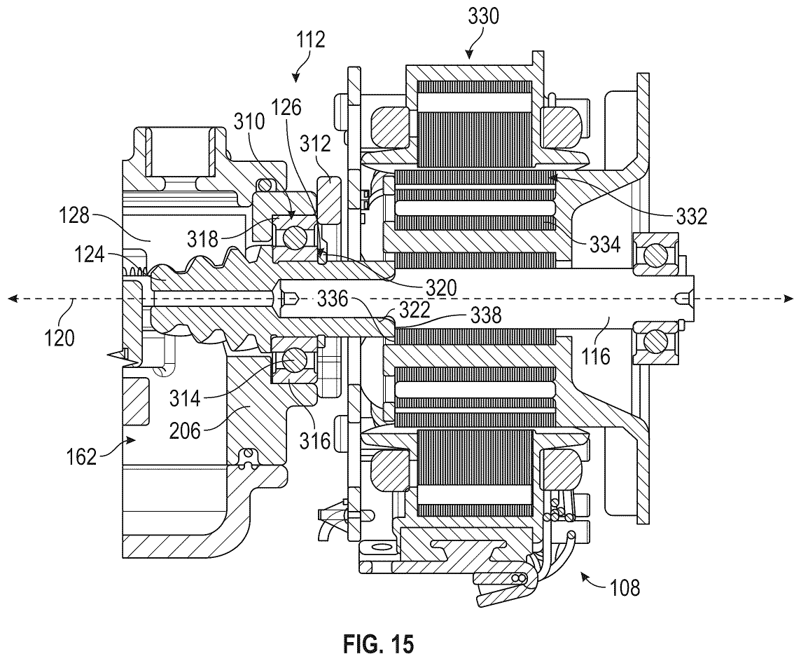

Referring to FIG. 15, examples of the present disclosure can provide an arrangement of the transmission 112 that can reduce or eliminate shifting a rotor of the motor 108 along the motor axis 120 during operation of the power tool 100. For example, the transmission 112 includes a central gear case cover 206 arranged adjacent the motor 108 and defines a bearing pocket 310. In some cases, a bearing 314 that includes an outer race 316 can be arranged within the bearing pocket 310. A bearing retainer 312 can be secured to the central gear case cover 206 (e.g., via fasteners such as screws) and can abut the outer race 316 to secure the outer race 316 within the bearing pocket 310. An inner race 318 of the bearing 314 can engage with the pinion 124 when the pinion 124 rotates relative to the outer race 316 and the central gear case cover 206. In some cases, the pinion 124 can be connected to an end of the motor shaft 116 and include a flange 322 that abuts an axial end face of the inner race 318. A retainer 320 (e.g., circlip, e-clip, etc.) can be provided within a groove 126 formed in the pinion 124. The retainer 320 can engage with an opposite axial end face of the inner race 318. Accordingly, a translational movement of the pinion 124 can be limited by placing the bearing 314 between a head portion of the pinion 124 and the retainer 320. In some cases, an axial position of the inner race 318 can be determined by the axial position of the outer race 316. In some cases, the axial position of the outer race 316 can be determined by the central gear case cover 206 and the bearing retainer 312. Accordingly, the arrangement of the central gear case cover 206 can determine the axial position of the pinion 124.

Further, the motor 108 can include a stator assembly 330 and a rotor assembly 332 that is rotatably supported on the motor shaft 116 relative to the stator assembly 330. The rotor assembly 332 can include a rotor core 334 (e.g., such as a lamination stack) that is arranged on the motor shaft 116 (e.g., via press fit or nominal interference fit). The rotor core 334 can define a first axial end surface 336 that contacts a corresponding second axial end surface 338 defined on the pinion 124. Thus, the pinion 124 fixes the rotor core 334 against translation in a forward direction (i.e., toward the central gear case cover 206).

During operation of the power tool 100, the rotor core 334 may have a tendency to slip on the motor shaft 116. In some cases, the rotor core 334 can translate axially toward the central gear case cover 206 due to the repeated reciprocating forces and impact forces acting on one or more of the drive piston 156, the striker 164, the anvil 172, or the tool bit 115. In some cases, the contact between the pinion 124 and the rotor core 334 can prevent the rotor core 334 from slipping and translating toward the central gear case cover 206 during operation of the power tool 100.

Returning to FIG. 2, one or more components of the power tool 100 can include various dimensions that characterize dimensional relationships between relative positions of different components of the power tool 100. In some cases, characterizing various dimensional relationships can be useful for varying an overall size of the power tool 100 (e.g., to provide a compact power tool vertically or horizontally). For example, the power tool 100 can include a distance D1 (e.g., a characteristic length, a sixth distance) measured between the crank axis 136 and a first longitudinal axis 350 that extends through a seat 175 of the anvil 172 that receives the tool bit 115. The distance D1 is measured in a direction parallel to the reciprocation axis 168. Because the anvil 172 is moveable within the spindle 160, the distance D1 is measured when the anvil 172 is fully retracted to be in contact with the rib 272 (e.g., an anvil seat) defined in the spindle 160 to limit movement of the anvil 172 toward the striker 164 (e.g., toward the crankshaft 132). In some cases, the fully retracted position of the anvil 172 can be associated with a working or impacting position of the power tool 100. Thus, the distance D1 corresponds with the shortest overall length of the power tool 100 when the tool bit 115 is inserted.

In some cases, the distance D1 can be between 100 mm and 200 mm, or between 120 mm and 180 mm, or between 130 mm and 160 mm, or about 142 mm. In some cases, the distance D1 can be less than 200 mm, less than 175 mm, or less than 156 mm. In some cases, a ratio of the distance D1 to an entire length L4 of the power tool 100 (e.g., without the tool bit installed or a rear housing of the full assembly) can be between 3:10 and 3:5, or between 2:5 and 1:2, or about 9:20. In particular, the entire length L4 can be measured between a second longitudinal axis 352 that extends through the distal end 178 of the retainer 176 and a third longitudinal axis 354 that extends through an end of the motor 108, as measured in a direction parallel to the reciprocation axis 168. In some cases, the entire length LA can be between 200 mm and 400 mm, or between 250 mm and 350 mm, or between 275 mm and 325 mm, or about 297 mm.

In some cases, the distance D1 can be varied to adjust the length L4 of the power tool 100 measured in the direction parallel to the reciprocation axis 168. For example, decreasing the distance D1 can shorten an overall length of the power tool 100, whereas increasing the distance D1 can lengthen the overall length of the power tool 100. In some examples, various dimensions of the spindle 160 can be adjusted to vary the distance D1. For example, the inner chamber 162 of the spindle 160 includes a length L3 (e.g., a fourth distance) as measured in a direction parallel to the reciprocation axis 168, and the spindle 160 can include an inner diameter ID as measured in a direction parallel to the crank axis 136. For example, the inner diameter ID can be between 15 mm and 40 mm, or between 25 mm and 35 mm, or about 32.5 mm. Further, the length L3 can be between 75 mm and 150 mm, or between 100 mm and 125 mm, or about 112 mm. In some cases, the length L3 can be decreased to shorten the distance D1 or increased to lengthen the distance D1. In some examples, the distance D1 is greater than 100% of the length L3, or greater than 120% of the length L3, or greater than 150% of the length L3, etc. In some cases, the inner diameter ID can correspondingly be increased or decreased to maintain the same volume of the interior chamber 162 (e.g., to maintain a desired impact energy via the air spring 190). In some examples, the inner diameter ID can be varied to achieve a desired amount of impact energy without lengthening or shortening the entire length L4. In some cases, the inner diameter ID can be substantially increased to receive the striker 164 having a greater volume or a greater mass, for example, to achieve a greater impact energy of the power tool 100. In some cases, a mass of the striker 164 can be between 70 grams and 160 grams, or between 100 grams and 130 grams, or about 123 grams.

Further, in some examples, the slots 292 of the spindle 160 can include a length L5, as measured in a direction parallel to the reciprocation axis 168. The length L5 can be adjusted to vary the length L3 or the distance D1. For example, the length L5 can be between 5 mm and 10 mm, or about 8 mm. In some cases, a distance D3 between an end of the spindle 160 and the crank axis 136, as measured in a direction parallel to the reciprocation axis 168, can be adjusted to vary the length D1. For example, the distance D3 can be between 15 mm and 25 mm, or between 17 mm and 23 mm, or about 21 mm. In some cases, a ratio of the distance D1 to the distance D3 can be between 10:1 and 5:1, or between 9:1 and 6:1, or about 27:4.

In some cases, the distance D1 can be determined based on a desired impact energy of the power tool 100. For example, the distance D1 of about 142 mm can be associated with an impact energy of the power tool 100 between 5 Joules (J) and 10 J, or between 8 J and 9 J. In some cases, the distance D1 can be characterized by between about 10 mm per 1 J and about 20 mm per 1 J, or between 15.8 mm per 1 J and 17.6 mm per 1 J. In some cases, the power tool 100 including a desired length of L3 can produce an average impact energy of between about 8 J and about 9 J per stroke. In some cases, the power tool 100 can maintain the predetermined amount of desired impact energy regardless of varying the distance D1. For example, based on the distance D1, one or more of a power rating of the motor 108, a driving mode of the power tool 100, or an operating speed of the motor 108 can be determined. In some cases, the power tool 100 can define a ratio of the impact energy to a bare weight of the power tool 100 (e.g., weight of the power tool 100 without a bit and the battery back 118) that is above 0.50 J/kg, or above 0.75 J/kg, or above 1.00 J/kg, or about 1.25 J/kg.

Further, the power tool 100 can be defined by a distance D2 (e.g., a fifth distance) between the crank axis 136 and the second longitudinal axis 352. The distance D2 is measured in a direction parallel to the reciprocation axis 168. In some cases, the distance D2 can be between 200 mm and 250 mm, or between 210 mm and 240 mm, or between 220 mm and 230 mm, or about 224 mm. In some cases, the distance D2 can be at least 100% of the distance D1, or at least 125% of the distance D1, or at least 150% of the distance D1, or about 160% of the distance D1. Put differently, a ratio between the distance D1 and the distance D2 can be between 1:1.3 and 1:2, or between 1:1.5 and 1:1.75, or about 1:1.6. In some cases, a ratio of the distance D2 and the entire length L4 of the power tool 100 can be between 1:2 and 1:1, or between 3:5 and 9:10, or between 7:10 and 4:5, or about 3:4. In some examples, a ratio of the length L3 to the distance D2 can be between 1:4 and 1:1, between 1:3.5 and 1:2.5, or about 1:2.

In some cases, the distance D2 can be varied to adjust an overall length of the power tool 100 measured in a direction parallel to the reciprocation axis 168. In some examples, dimensions of different components of the power tool 100 (e.g., the spindle 160, the tool holder 130, the retainer 176, the spindle case 214, etc.) can be adjusted to reduce the distance D1 or the distance D2. For example, the spindle 160 can include a length L6 (e.g., a third distance) as measured in a direction parallel to the reciprocation axis 168. In some cases, the length L6 can be between 150 mm and 250 mm, or between 175 mm and 225 mm, or about 201 mm. In some cases, a ratio of the length L3 to the length L6 can be less than 1:1, less than 1:1.5, less than 1:2, less than 1:2.5, between 1:1 and 1:2.5, between 1:1.5 and 1:2, or about 1:1.8. In some cases, a ratio of the length L6 to the distance D1 can be between 2:1 and 1:1, or between 3:2 and 5:4, or about 1.4:1.

In some cases, the length L6 can be adjusted to vary one or more of the distance D1, the distance D2, or the length L4. In some cases, one or more of the distance D1, the distance D2, the distance D3, the length L3, and the length L5, and the length L6 can be adjusted to provide an overall reduced or increased length L4 of the power tool 100. In some cases, reducing the length L3 can reduce the distance D1 or the distance D2. In some cases, reducing the length L6 can reduce the distance D1 or the distance D2. In some cases, reducing the length L5 or the distance D3 can reduce the distance D1 or the distance D2. In some cases, reducing the distance D1 can reduce the distance D2. Accordingly, dimensions of the power tool 100 can provide a horizontally compact power tool in a direction parallel to the reciprocation axis 168.

In some examples, dimension of the power tool 100 can further provide a vertically compact power tool 100 in a direction parallel to the crank axis 136. With continued reference to FIG. 2, a distance D4 (e.g., a seventh distance) between the motor axis 120 and the reciprocation axis 168 is shown. The distance D4 is measured in a direction parallel to the crank axis 136. In particular, the distance D4 can be between 10 mm and 30 mm, or between 15 mm and 25 mm, or about 18 mm. In some cases, a ratio of the distance D4 and the inner diameter ID can be between 2:5 and 7:10, or between 1:2 and 3:5, or about 11:20. In some cases, the distance D4 can be adjusted to increase or decrease an overall height of the power tool 100 as measured in a direction parallel to the crank axis 136. For example, the gear 128 can be connected to the crankshaft 132 at a height closer to the reciprocation axis 168, and the motor 108 can engage with the gear 128 at a height closer to the reciprocation axis 168. Accordingly, the distance D4 can be decreased, and the overall height of the power tool 100 can be decreased. Therefore, adjusting the distance D4 can provide a vertically compact power tool 100.

In some implementations, devices or systems disclosed herein can be utilized, manufactured, or installed using methods embodying aspects of the invention. Correspondingly, any description herein of particular features, capabilities, or intended purposes of a device or system is generally intended to include disclosure of a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

Also as used herein, unless otherwise defined or limited, directional terms are used for convenience of reference for discussion of particular figures or examples or to indicate spatial relationships relative to particular other components or context, but are not intended to indicate absolute orientation. For example, references to downward, forward, or other directions, or to top, rear, or other positions (or features) may be used to discuss aspects of a particular example or figure, but do not necessarily require similar orientation or geometry in all installations or configurations.

Also as used herein, unless otherwise limited or defined, “substantially parallel” indicates a direction that is within ±12 degrees of a reference direction (e.g., within ±6 degrees or ±3 degrees), inclusive. Similarly, unless otherwise limited or defined, “substantially perpendicular” similarly indicates a direction that is within ±12 degrees of perpendicular a reference direction (e.g., within ±6 degrees or ±3 degrees), inclusive. Correspondingly, “substantially vertical” indicates a direction that is substantially parallel to the vertical direction, as defined relative to the reference system (e.g., a local direction of gravity, by default), with a similarly derived meaning for “substantially horizontal” (relative to the horizontal direction). Discussion of directions “transverse” to a reference direction indicate directions that are not substantially parallel to the reference direction. Correspondingly, some transverse directions may be perpendicular or substantially perpendicular to the relevant reference direction.

Unless otherwise specifically indicated, ordinal numbers are used herein for convenience of reference, based generally on the order in which particular components are presented in the relevant part of the disclosure. In this regard, for example, designations such as “first,” “second,” etc., generally indicate only the order in which a thus-labeled component is introduced for discussion and generally do not indicate or require a particular spatial, functional, temporal, or structural primacy or order.

The previous description of the disclosed embodiments is provided to enable any person skilled in the art to make or use the invention. Given the benefit of this disclosure, various modifications to these embodiments will be readily apparent to those skilled in the art, and the principles defined herein may be applied to other embodiments without departing from the spirit or scope of the invention. Thus, the invention is not intended to be limited to the embodiments shown herein but is to be accorded the widest scope consistent with the principles and novel features disclosed herein.

What is claimed is:

1. A power tool comprising:
a motor;
a spindle defining a first end with a slot; and
a crankshaft including a counterweight and a crank pin that are rotated by the motor about a crank axis so that at least one of the counterweight and the crank pin is rotated through the slot.

2. The power tool of claim 1, wherein the counterweight includes a first distance and the crank pin includes a second distance that is greater than the first distance, the first distance and the second distance each measured in a direction perpendicular to the crank axis.

3. The power tool of claim 1, wherein the spindle has a second end opposite the first end and defines a third distance taken between the first end and the second end of the spindle; and
wherein the spindle includes an anvil seat between the first end and the second end, and defines a fourth distance between the anvil seat and the first end of the spindle.

4. The power tool of claim 3, wherein a ratio of the fourth distance to the third distance is between 1:1.5 and 1:2.

5. The power tool of claim 3 further comprising a fifth distance between the crank axis and the second end of the spindle,
wherein a ratio of the fourth distance to the fifth distance is between 1:1.5 and 1:2.5.

6. The power tool of claim 3 further comprising an anvil received in the spindle, the anvil defining a bit seat configured to receive a tool bit,
wherein a sixth distance is defined between the bit seat and the crank axis when the anvil is in contact with the anvil seat.

7. The power tool of claim 6, wherein the sixth distance is between 130 mm and 160 mm.

8. The power tool of claim 7, wherein an average impact energy imparted at the anvil is between about 7.5 Joules and 9 Joules.

9. The power tool of claim 6, wherein a ratio of the sixth distance to an entire length of the power tool, as measured in a direction perpendicular to the crank axis, is between 1:2 and 1:2.5.

10. The power tool of claim 6, wherein a ratio of the third distance to the sixth distance is between 3:2 and 5:4.

11. The power tool of claim 6, wherein a ratio of the sixth distance to the fourth distance is between 9:1 and 6:1.

12. The power tool of claim 6 further comprising a fifth distance between the crank axis and the second end of the spindle,
wherein a ratio of the sixth distance to the fifth distance is between 1:1.5 and 1:1.75.

13. The power tool of claim 1, wherein the motor defines a motor axis and the spindle defines a spindle axis, and
wherein a ratio of a seventh distance between the motor axis and the spindle axis to an inner diameter of the spindle is between 1:2 and 3:5.

14. A power tool comprising:
a spindle defining an anvil seat between a first end and a second end;
an anvil defining a bit seat configured to receive a tool bit and engaging with the anvil seat to define a characteristic length between the bit seat and the first end of the spindle that is less than about 175 mm; and
a crankshaft rotated by a motor about a crank axis to impart impacts at the anvil with an average impact energy that is between about 7.5 Joules and about 9 Joules.

15. The power tool of claim 14, wherein the first end of the spindle defines a slot and the crankshaft includes a counterweight that is rotated through the slot.

16. The power tool of claim 14, wherein spindle chamber length defined between the anvil seat and the first end of the spindle is between about 100 mm and about 125 mm.

17. The power tool of claim 14, wherein a distance from the crank axis to the first end of the spindle is between about 200 mm and about 250 mm.

18. The power tool of claim 15, wherein a maximum radius of the counterweight is between about 20 mm and about 25 mm.

19. The power tool of claim 14, wherein the spindle has an inner diameter that is between about 25 mm and about 35 mm.

20. A power tool comprising:
a motor;
a spindle defining a first end with a slot and an anvil seat spaced from the first end;
an anvil defining a bit seat configured to receive a tool bit and engaging with the anvil seat to define a characteristic length between the bit seat and the first end of the spindle that is less than about 175 mm; and
a crankshaft including a counterweight and a crank pin that are rotated by the motor about a crank axis so that at least one of the counterweight and the crank pin is rotated through the slot.
